(19) United States
(12) Patent Application Publication
(10) Pub. No.: US 2024/0092419 A1
(43) Pub. Date: Mar. 21, 2024

(54) Steering System for a Vehicle, in Particular a Utility Vehicle

(71) Applicant: KNORR-BREMSE Systeme fuer Nutzfahrzeuge GmbH, Muenchen (DE)

(72) Inventors: Rainer LANG, Schwaebisch Gmuend (DE); Klaus PETERREINS, Filderstadt (DE); Christian KALTENBACH, Stuttgart (DE)

(21) Appl. No.: 18/275,645

(22) PCT Filed: Jan. 7, 2022
(86) PCT No.: PCT/EP2022/050236

§ 371 Date: Aug. 3, 2023

(30) Foreign Application Priority Data
Feb. 4, 2021 (DE) 10 2021 102 616.4

(51) Int. Cl. B62D 5/065; B62D 5/14; B62D 5/24; F15B 15/18

(52) U.S. Cl. CPC B62D 5/065; B62D 5/14; B62D 5/24; F15B 15/18

(57) ABSTRACT

A steering system for a vehicle, in particular a utility vehicle, has at least one steering transmission, in particular a ball nut hydraulic steering transmission; at least one steering mechanism for steering at least one first vehicle wheel and for steering at least one second vehicle wheel, wherein the steering transmission is coupled to the steering mechanism; at least one hydraulic pump for supplying the steering transmission with hydraulic fluid; and at least one drive motor which is provided independently and/or separately from the traction drive of the vehicle and which is coupled to the hydraulic pump in order to drive same. In the assembled state, the steering transmission, the hydraulic pump, and the drive motor are designed as a unit.

### BACKGROUND AND SUMMARY

The present invention concerns a steering system for a vehicle, in particular a utility vehicle, with at least one steering gear, in particular a ball-and-nut power steering gear, and with at least one steering mechanism for steering at least one first vehicle wheel and for steering at least one second vehicle wheel.

The invention is particularly intended for a steering system in light and heavy utility vehicles which are equipped with electronic power steering (EPS) based on an electrohydraulic principle. The EPS steering system has a discontinuous operating behavior, i.e. the hydraulic fluid present in the hydraulic circuit of the steering system is conveyed by a hydraulic pump only during steering movements (principle: power on demand). When no steering is performed, the hydraulic fluid remains at rest (delivery volume of hydraulic pump is substantially zero). The drive for the hydraulic pump is a motor, e.g. a drive motor independent of the vehicle drive or traction drive (e.g. an electric motor in the form of an electric BLCD radial flux motor). This type of steering system may be used as a power-on-demand steering system (e.g. in electrified utility vehicles without combustion engine), or to implement automated driving requirements autonomously without driver intervention (e.g. via driver assistance systems).

Thus in future, ever increasing functional requirements will be imposed on steering systems for vehicles, in particular utility vehicles, since the steering system plays an important role in the (partial) automation of vehicles.

Here it is particularly important that the steering system functions precisely and reliably, meets these increasing functional requirements but nonetheless can be further optimized with respect to installation space requirements. The increase in function density in vehicles concerns not only the steering system, so that for substantially the same installation space in the vehicle, the steering system should also be optimized with respect to installation space so that further functions of the steering system, and also of the vehicle itself, can be implemented.

Steering systems for vehicles are already known from the prior art.

DE 10114600 A1 discloses a vehicle steering system having a steering actuating device, in particular a steering hand wheel, which can be actuated by the driver; an electromechanical actuator for controlling a respective steerable wheel, situated on the right and on the left of a vehicle body, of a wheel pair of a steerable vehicle axle; means which, on failure of or a fault in one of the two actuators assigned to a respective steerable vehicle axle, ensure the control of both vehicle wheels of this vehicle axle by the other, still functioning actuator.

DE 112012806263 T5 furthermore discloses a vehicle steering device comprising: a steering device which is configured to turn a steered wheel according to operation of the vehicle steering wheel, wherein the steering device contains a first motor and a second motor for steering, the electrical characteristics of which are set in common relative to one another; a first current sensor which is configured to detect a first current value of a current flowing through the first motor; a second current sensor which is configured to detect a second current value of a current flowing through the second motor; and abnormality diagnosis units.

Also, DE 102011121827 A1 describes a power steering system with a force cylinder which is provided with a pair of pressure chambers in order to provide a steering force to at least one of the steered wheels, based on a pressure difference between the pair of pressure chambers; a steering mechanism for deflecting the steered wheel according to a steering-turning actuation of a steering wheel; a first pump provided with a first drive shaft which, in accompaniment with rotation of the first drive shaft, draws in and expels working fluid in order to supply the working fluid to the force cylinder, wherein the first pump is driven in rotation by a first drive source; a second pump provided with a second drive shaft which, in accompaniment with the rotation of the second drive shaft, draws in and expels working fluid in order to supply the working fluid to the force cylinder; a second drive source, which is a drive source different from the first drive source, and which is formed by an electric motor and drives the second pump in rotation; a control valve arranged in the steering mechanism for selectively supplying the working fluid, supplied by the first or second pump, to the pair of pressure chambers according to a steering-turning movement of the steering wheel.

Such steering devices from the prior art are still costly and complex or constructed from many components, require a large installation space and have a high weight. Accordingly, there are various fault sources which, in the least favorable case, may lead to failure of the vehicle.

The object of the present invention is therefore to advantageously refine a steering system of the type cited initially, in particular in that the steering system has a lower weight, is optimized with respect to installation space, and implements steering commands at the vehicle wheels more precisely or dynamically.

This object is achieved by a steering system with the features of the independent claims. According to this, it is provided that a steering system for a vehicle, in particular a utility vehicle, comprises at least one steering gear, in particular a ball-and-nut power steering gear; at least one steering mechanism for steering at least one first vehicle wheel and for steering at least one second vehicle wheel, wherein the steering gear is coupled to the steering mechanism; at least one hydraulic pump for supplying the steering gear with hydraulic fluid; and at least one drive motor which is provided independently of and/or separately from the traction drive of the vehicle and which is coupled to the hydraulic pump in order to drive same, wherein in mounted state, the steering gear, the hydraulic pump, and the drive motor are configured as a structural unit.

The invention is based on the fundamental concept that the steering system has a structurally and functionally integrated steering gear. In contrast to the prior art, in which in particular the hydraulic pump and ancillaries such as expansion tank or valves etc. are arranged in the vicinity of the traction drive, according to the present invention, the steering gear, the hydraulic pump and the drive motor are combined as a common structural unit. Thus the hydraulic lines may be substantially shorter, whereby additionally the heat and flow losses are reduced. In addition, the steering system may be made lighter in weight and require less installation space thanks to such a design. In this integral plug-and-play approach, the hydraulic circuit is decoupled from the traction drive of the vehicle (usually a combustion engine or hybrid drive) and arranged on the steering gear as a compact unit. In this context, it is also contemplated that the hydraulic pump and drive motor are configured as a preassembled common motor-pump unit and are flanged to the steering gear in order to form the structural unit.

Also, it may be provided that the drive motor is coupled to the hydraulic pump directly, in particular without a clutch. In this way, the motor-pump unit may be more compact, giving further advantages with respect to installation space and weight. Also, this motor-pump unit may thereby be made more rigid so that less material fatigue or less wear occurs, and hence a better efficiency of the motor-pump unit can be achieved.

It is furthermore contemplated that that the drive motor and the hydraulic pump have at least one common drive shaft. With this design, the motor-pump unit may be more compact, giving further advantages with respect to installation space and weight. Also, with this design of drive shaft (e.g. with targeted diameter selection), the individual requirements of the hydraulic pump and drive motor may be specifically addressed. Accordingly, the motor-pump unit may have fewer components, making it less complex in construction and less susceptible to fault, but nonetheless can meet the requirements for a drive shaft for both the hydraulic pump and drive motor.

It is also contemplated that the steering system has at least one first shaft bearing device and at least one second shaft bearing device, via which the drive shaft is at least partly supported in mounted state. In addition to the first and second shaft bearing devices, the electric motor and/or hydraulic pump may have further bearing devices in their respective housings. The first and second shaft bearing devices serve in particular to combine the sometimes contradictory requirements for a drive shaft for both the hydraulic pump and drive motor. The drive motor requires a drive shaft and bearing which are as rigid or inflexible as possible in order, e.g. for an electric motor as a drive motor, to maintain a constant air gap (between stator and rotor) at different torques and shaft speeds. The hydraulic pump however requires a shaft which is as flexible, elastic or yielding as possible, in order to allow in particular radial movements inside the hydraulic pump within defined limits. This is necessary to guarantee pressure and temperature compensation within the pump, and thus keep the operating range of the pump as large as possible with respect to pressure and temperature requirements.

It is also possible that the first shaft bearing device and the second shaft bearing device form a hybrid bearing system. A hybrid bearing system is particularly suitable for combining the sometimes contradictory requirements for a drive shaft of the motor-pump unit. Thus for example the first shaft bearing device may be rigid in the region of the drive motor, at least with respect to the occurring flexion loads on the drive shaft. In contrast, by an axially defined distance of the second shaft bearing device from the hydraulic pump and by corresponding design, it is possible to make the drive shaft elastic or flexible in the region of the hydraulic pump, at least with respect to the occurring flexion loads.

It may furthermore be provided that in mounted state, the first shaft bearing device is arranged on the drive shaft between the drive motor and the hydraulic pump. This arrangement is particularly advantageous for a bend-stiffening of the drive shaft in the region of the drive motor. The first shaft bearing device generates a radial bearing reaction force between the hydraulic pump and the drive motor, which compensates for the radial or bending forces caused by the hydraulic pump and the resulting bending moments. Thus only very small bending deformations of the drive shaft occur inside the drive motor, which has a positive effect on the efficiency.

It is also contemplated that the first shaft bearing device is configured as an in particular double-row grooved ball bearing. A grooved ball bearing is a well-known component which has been used millions of times and offers clearly defined advantages, such as a low radial bearing play with simultaneously defined radial load-bearing capacity and very low costs, making it ideal for the first shaft bearing device. A double-row grooved ball bearing is however particularly suitable since its axial dimension, although larger than that of a single-row ball bearing, gives a more robust bearing with higher load-bearing capacity. Also, the additional axial extent allows a stiffer bearing, whereby the efficiency of the drive motor is increased for the same reasons as already explained above.

In addition, it is contemplated that the drive shaft has an axial end which, in mounted state, protrudes from a side of the hydraulic pump facing away from the drive motor, wherein the second shaft bearing device is arranged at this axial end of the drive shaft. With such a design, the lever arm between the radial reaction force of the second shaft bearing device and the radial forces occurring in the hydraulic pump is enlarged. The larger lever arm leads to a greater elasticity or flexibility of the drive shaft in the region of the hydraulic pump, so that the requirements for flexibility of the drive shaft in the hydraulic pump can be addressed even better by such an arrangement of the second shaft bearing device.

It is furthermore possible that the second shaft bearing device is configured as a hydrodynamic plain bearing. In comparison with a grooved ball bearing, a hydrodynamic plain bearing has a greater bearing play in the radial direction. This further increases the elasticity or flexibility of the drive shaft in the hydraulic pump, so that the requirements for the drive shaft in the region of the hydraulic pump can be met even better. Also, hydrodynamic plain bearings are already well-known components which can absorb particularly high radial forces in a small installation space.

In addition, it may be provided that the drive haft has a motor shaft portion in the region of the drive motor and a pump shaft portion in the region of the hydraulic pump, wherein the motor shaft portion has a greater diameter than the pump shaft portion. As well as the above-mentioned design of the first and second shaft bearing devices, this design of the shaft portions offers a further structural possibility for combining the sometimes contradictory requirements for a drive shaft for the drive motor and hydraulic pump more advantageously. Because of the reduced diameter of the pump shaft portion, its polar resistance moment is reduced so that the required elastic properties, in particular under flexion load, are further improved. The reverse applies to the motor shaft portion, the greater diameter of which leads to a correspondingly increased polar resistance moment and accordingly a stiffer shaft portion, whereby the efficiency of the drive motor can be further improved, as already explained above.

It is furthermore contemplated that the drive motor is configured as an electric motor. The integration of the electric motor into the structural unit, additionally consisting of the hydraulic pump and steering gear, has the advantage that the electric motor can be controlled or regulated very well, i.e. can be controlled highly dynamically, and in particular rotation direction changes can be controlled or regulated very easily, precisely and rapidly. Also, an electric motor can easily be integrated in or coupled to existing control or regulation device architectures. Thus it is possible that the electric motor has its own control unit. Additionally or alternatively, it is possible that the electric motor can be actuated by a control unit of the steering system or by a vehicle control unit. These control units may evidently also perform tasks of regulating the electric motor. The electric motor may also be controlled or regulated so as to implement driver assistance systems such as lane-holding assistant, congestion assistant, wind-compensation assistant, or partly or fully autonomous steering commands.

It is also contemplated that the hydraulic pump is configured as a bidirectional hydraulic pump. This design has the particular advantage that the hydraulic flow, which pressurizes a double-action piston in the steering gear, can be reversed by the pump. Accordingly, there is no need for complex and costly control valves, so actuation or supply of the steering gear is simplified. Also, the complexity of regulation and/or control systems for the steering system is reduced, since there is no need for actuation of these additional valves.

Further details and advantages of the invention will be explained in more detail below with reference to an exemplary embodiment shown in the drawings.

### BRIEF DESCRIPTION OF THE DRAWINGS

FIG. 1 is a schematic, perspective illustration of a steering system from the prior art;

FIG. 2a is a first schematic block diagram of an exemplary embodiment of a steering system according to the invention; and

FIG. 2b is a second schematic block diagram of the exemplary embodiment of the steering system according to the invention from FIG. 2a.

### DETAILED DESCRIPTION OF THE DRAWINGS

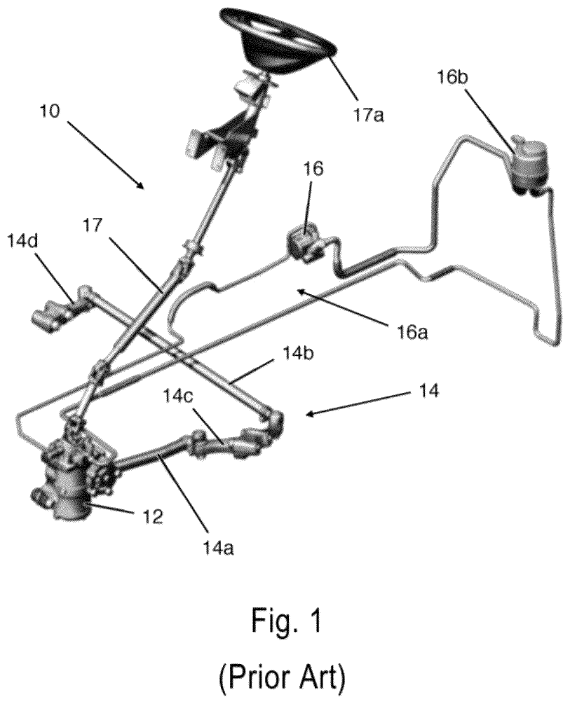

FIG. 1 shows a schematic, perspective illustration of a steering system 10 from the prior art. The steering system 10 substantially consists of a steering gear (transmission) 12 in the form of a ball-and-nut power steering gear, and a steering mechanism 14 coupled therewith for steering the two vehicle wheels (not shown in FIG. 1).

The steering mechanism has a first and second steering rod 14a, 14b and a first and second track rod 14c, 14d.

According to FIG. 1, the first steering rod 14a and the first track rod 14c are connected in articulated fashion to a first wheel carrier for steering or pivoting thereof, wherein the first steering rod 14a is coupled to an output shaft of the steering gear 12.

The second steering rod 14b is in turn hinge-mounted via a pusher on the first wheel carrier, and thus couples in articulated fashion the first wheel carrier to the second wheel carrier via the pusher and the second track rod 14d.

Furthermore, the steering system 10 has a hydraulic pump 16 which is coupled via pipework 16a to the steering gear 12 in order to supply hydraulic fluid thereto.

An expansion tank 16b is arranged in the pipework 16a between the hydraulic output of the steering gear 12 and the input of the hydraulic pump 16.

Also, the steering system according to FIG. 1 contains a steering column 17 in the form of a multi-element linkage, and a steering wheel 17a rotationally fixedly coupled thereto for manual control of the steering gear 12, which leads to a pivoting of the steering mechanism 14 and hence steering of the vehicle wheels.

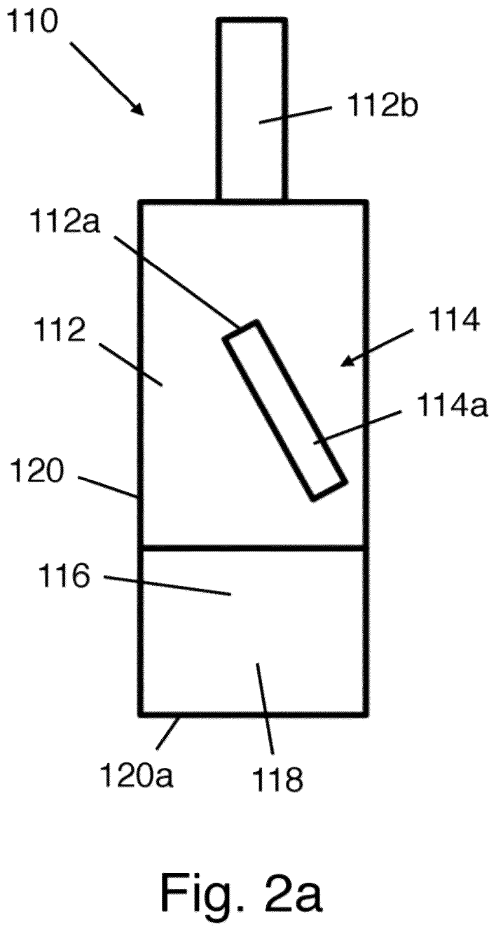

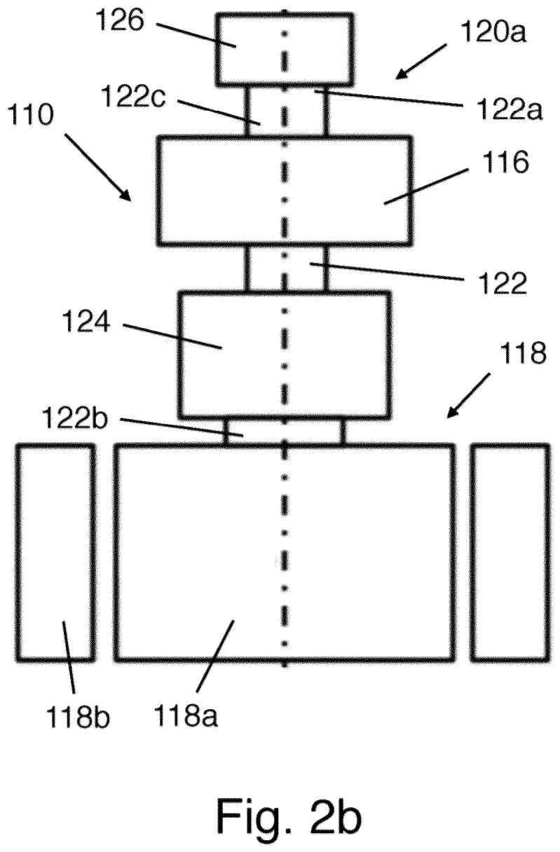

FIG. 2a shows a first schematic block diagram of an exemplary embodiment of a steering system 110 according to the invention.

Components of the steering system 110 according to the invention, which are the same or similar to those of the steering system 10 from FIG. 1 according to the prior art, carry a respective reference number increased by 100.

The steering system 110 for a vehicle according to FIG. 2a has a steering gear (transmission) 112. The steering gear 112 is configured as a ball-and-nut power steering gear and the vehicle is accordingly configured as a utility vehicle.

Furthermore, the steering system 110 has a first steering mechanism 114 for steering a first vehicle wheel and for steering a second vehicle wheel.

FIG. 2a shows schematically only the first steering rod 114a, as representative of the steering mechanism 114, which rod is coupled rotationally fixedly to an output shaft 112a of the steering gear 112.

The steering gear 112 is thus coupled to the steering mechanism 114 via the first steering rod 114a.

The steering system 110 also comprises a hydraulic pump 116 for supplying hydraulic fluid to the steering gear 112.

The hydraulic pump 116 is configured as a bidirectional hydraulic pump 116.

In this case, bidirectional means that the hydraulic pump 116 can switch the pressure and suction sides by switching its rotational direction (via the drive motor 118) and thus reverse a hydraulic flow according to the steering direction.

This reversed hydraulic flow then loads the double-action steering cylinder inside the steering gear according to the required or controlled steering movement.

Also, a drive motor 118 is provided which is independent of the traction drive of the vehicle and arranged separately, and which is coupled to the hydraulic pump 116 for driving this.

According to the fundamental concept of the invention, in mounted state, the steering gear 112, the hydraulic pump 116 and the drive motor 118 are configured as a common structural unit 120.

Further ancillaries such as e.g. an expansion tank for the hydraulic pump 116, or control and regulation units of the drive motor 118, may also be integrated in the structural unit 120 but are not shown in FIG. 2a.

It may furthermore be provided that the hydraulic pump 116 and the drive motor 118 are configured as a preassembled common motor-pump unit 120a and flanged to the end face of the steering gear 112 in order to form a structural unit 120.

The motor-pump unit 120a may here in particular be flanged to the steering gear 112 at the end face opposite a mechanical through-drive 112b in order to form a mechanical coupling to a steering column.

Alternatively, it is also contemplated that the motor-pump unit 120a may be flanged to the end face of the steering gear 112 in the region of the mechanical through-drive 112b.

Alternatively, the motor-pump unit 120a may also be flanged to an outside of the steering gear 112 in its axial extent.

As further evident from FIG. 2a, no hydraulic lines or additional hydraulic switching valves are shown; only the mechanical through-drive 112b for mechanical coupling to a steering column is illustrated.

FIG. 2b shows a second schematic block diagram of the exemplary embodiment of the steering system according to the invention from FIG. 2a.

This essentially shows the motor-pump unit which substantially consists of the hydraulic pump 116 and drive motor 118.

The drive motor 118 is here coupled directly to the hydraulic pump 116.

In this context, direct may mean that the drive motor 118 and hydraulic pump 116 are connected together rotationally fixedly without intermediate components.

No clutch is thus provided.

Furthermore, in this context of direct coupling, it should be pointed out that the drive motor 118 and hydraulic pump 116 have a common drive shaft 122 for direct coupling.

The drive shaft 122 extends axially from the drive motor 118 up to the hydraulic pump 160, where in mounted state it protrudes axially from the hydraulic pump 116 in the direction of the steering gear 112.

The drive motor 118 is configured as an electric motor and has a rotor 118a, which is rotationally fixedly coupled to the drive shaft 122, and a stator 118b.

The steering system 110, and in particular the motor-pump unit 120a, furthermore comprises a first shaft bearing device 124 and a second shaft bearing device 126.

In mounted state, the drive shaft is at least partially mounted via the first and second shaft bearing devices 124, 126.

In addition, the drive motor 118 and hydraulic pump 116 may have further bearing devices (not shown in FIG. 2b) in their respective housings.

According to FIG. 2b, in mounted state, the first shaft bearing device 124 is arranged on the drive shaft 122 between the drive motor 118 and the hydraulic pump 116.

It is provided here that the first shaft bearing device 124 is arranged axially closer to the drive motor 118 than to the hydraulic pump 116.

It is also contemplated in this connection that the first shaft bearing device 124 is flanged directly to the housing of the drive motor 118 through a cover, or the first shaft bearing device 124 is directly mounted in the housing of the drive motor 118.

Additionally or alternatively, it may be provided that the drive motor 118 and the hydraulic pump 116 are coupled together by a flange (not shown in FIG. 2b), and the first shaft bearing device 124 is received by or mounted via the flange.

The first shaft bearing device 124 is configured as a grooved ball bearing.

Particularly advantageously, the grooved ball bearing may itself be configured as a double-row grooved ball bearing.

As described above, the drive shaft 122 has an axial end 122a which, in mounted state, protrudes from a side of the hydraulic pump 116 facing away from the drive motor 118.

The second shaft bearing device 126 is arranged at this axial end 122a.

The second shaft bearing device 126 may be arranged on or flanged directly onto the housing of the hydraulic pump 116, or have a defined axial distance from this.

It is also contemplated that the second shaft bearing device 126 is flanged to the hydraulic pump 116 via a cover, or is a direct component of the housing of the hydraulic pump 116.

The second shaft bearing device 126 is configured as a hydrodynamic plain bearing.

The first and second shaft bearing devices 124, 126 thus form a hybrid bearing system.

A hybrid bearing system means that the first and second shaft bearing devices 124, 126 differ in their respective bearing concepts or bearing designs.

The hybrid bearing system of a double-row grooved ball bearing and a hydrodynamic plain bearing is thus merely exemplary, so other hybrid bearing designs are also possible.

Other roller bearing forms may also be used, such as cylinder roller bearings, needle roller bearings, tapered roller bearings, spherical roller bearings or toroidal roller bearings.

The same applies to the plain bearing, where here for example a hydrostatic plain bearing would also be conceivable.

Bearing materials for the plain bearing bush may include bronze (copper-tin alloy), white metal (lead-tin alloy), lead-alloy bearing metals, aluminum alloys, plastics (e.g. PTFE), ceramics (also possibly fiber-reinforced), graphite or brass alloys.

As FIG. 2b also shows, the drive shaft 122 has a motor shaft portion 122b in the region of the drive motor 118, and a pump shaft portion 122c in the region of the hydraulic pump.

The motor shaft portion 122b has a greater diameter than the pump shaft portion 122c.

According to FIG. 2b, the first shaft bearing device 124 is also mounted on a shaft portion which corresponds to the diameter of the pump shaft portion 122c.

Alternatively, the first shaft bearing device 124 may be mounted on a shaft portion which corresponds to the diameter of the motor shaft portion 122b or a diameter between the two diameters.

According to FIG. 2b, the drive shaft 122 is shown schematically as single-step shaft, wherein the drive shaft 122 may also have multiple steps or shaft shoulders.

### LIST OF REFERENCE SIGNS

10 Steering system
12 Steering gear (transmission)
14 Steering mechanism
14a First steering rod
14b Second steering rod
14c First track rod
14d Second track rod
16 Hydraulic pump
16a Pipework
16b Expansion tank
17 Steering column
17a Steering wheel
110 Steering system
112 Steering gear
112a Output shaft of steering gear
112b Through-drive
114 Steering mechanism
114a First steering rod
116 Hydraulic pump
118 Drive motor
118a Rotor
118b Stator
120 Structural unit
120a Motor-pump unit
122 Drive shaft
122a Axial end of drive shaft
122b Motor shaft portion
122c Pump shaft portion
124 First shaft bearing device
126 Second shaft bearing device

1.-12. (canceled)

13. A steering system for a utility vehicle, comprising:
at least one steering gear;
at least one steering mechanism for steering at least one first vehicle wheel and for steering at least one second vehicle wheel, wherein the steering gear is coupled to the steering mechanism;
at least one hydraulic pump for supplying the steering gear with hydraulic fluid; and
at least one drive motor which is provided independently of and/or separately from a traction drive of the vehicle and which is coupled to the hydraulic pump in order to drive the hydraulic pump,
wherein, in a mounted state, the steering gear, the hydraulic pump, and the drive motor are configured as a structural unit.

14. The steering system according to claim 13, wherein
the steering gear is a ball-and-nut power steering gear.

15. The steering system according to claim 13, wherein
the drive motor is coupled to the hydraulic pump directly without a clutch.

16. The steering system according to claim 15, wherein
the drive motor and the hydraulic pump have at least one common drive shaft.

17. The steering system according to claim 16, wherein
the steering system has at least one first shaft bearing device and at least one second shaft bearing device, via which the drive shaft is at least partly supported in the mounted state.

18. The steering system according to claim 17, wherein
the first shaft bearing device and the second shaft bearing device form a hybrid bearing system.

19. The steering system according to claim 17, wherein
in the mounted state, the first shaft bearing device is arranged on the drive shaft between the drive motor and the hydraulic pump.

20. The steering system according to claim 17, wherein
the first shaft bearing device is configured as a double-row grooved ball bearing.

21. The steering system according to claim 17, wherein
the drive shaft has an axial end which, in the mounted state, protrudes from a side of the hydraulic pump facing away from the drive motor, and
the second shaft bearing device is arranged at said axial end of the drive shaft.

22. The steering system according to claim 17, wherein
the second shaft bearing device is a hydrodynamic plain bearing.

23. The steering system according to claim 16, wherein
the drive shaft has a motor shaft portion in a region of the drive motor and a pump shaft portion in a region of the hydraulic pump, and
the motor shaft portion has a greater diameter than the pump shaft portion.

24. The steering system according to claim 13, wherein
the drive motor is an electric motor.

25. The steering system according to claim 13, wherein
the hydraulic pump is a bidirectional hydraulic pump.
